(19) United States
(12) Patent Application Publication
(10) Pub. No.: US 2010/0026239 A1
(43) Pub. Date: Feb. 4, 2010

(54) CHARGING SYSTEM AND CHARGING APPARATUS THEREOF

(75) Inventors: XIONG LI, Shenzhen City (CN); YUNG-HUNG CHU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/508,516

(22) Filed: Jul. 23, 2009

(30) Foreign Application Priority Data
Jul. 31, 2008 (CN) 200810303262.X

(51) Int. Cl. H02J 7/02

(52) U.S. Cl. 320/109

(57) ABSTRACT

A charging apparatus for a robot includes a base board, a supporting portion disposed on the base board, a rotating member rotatably attached on the supporting portion, and a driving member engageable with the rotating member. The driving member drives the rotating member to rotate with respect to the supporting portion. A power supply terminal is disposed on the rotating member and rotates with the rotating member to electrically connect with the robot for recharging the robot.

### BACKGROUND

1. Technical Field

The present disclosure relates to charging systems, and more particularly to a charging system for a robot.

2. Description of Related Art

Conventional robots generally utilize rechargeable batteries as power sources. When the voltage of a rechargeable battery is lower than a predetermined value, the battery needs to be recharged via a charging apparatus. A robot usually includes a wireless for communicating with the charging apparatus in order to guide the robot to move toward the charging apparatus. When the robot approaches the charging apparatus, care must be taken to plug the connector on the robot to the connector on the charging apparatus or the connector pins may be damaged or the charging connector may even scratch the robot.

Therefore, a need exits for providing a charging apparatus that reduces damages to the connector and the robot.

### BRIEF DESCRIPTION OF THE DRAWINGS

FIG. 1 is an exploded isometric view of a charging system, comprising a robot and a charging apparatus, in accordance with an exemplary embodiment.

FIG. 2 is an isometric view of a charging system of FIG. 1, with the robot prior to engaging with the charging apparatus.

FIG. 3 is an isometric view of the charging system of FIG. 1, with the robot being docked in the charging apparatus and charging.

### DETAILED DESCRIPTION

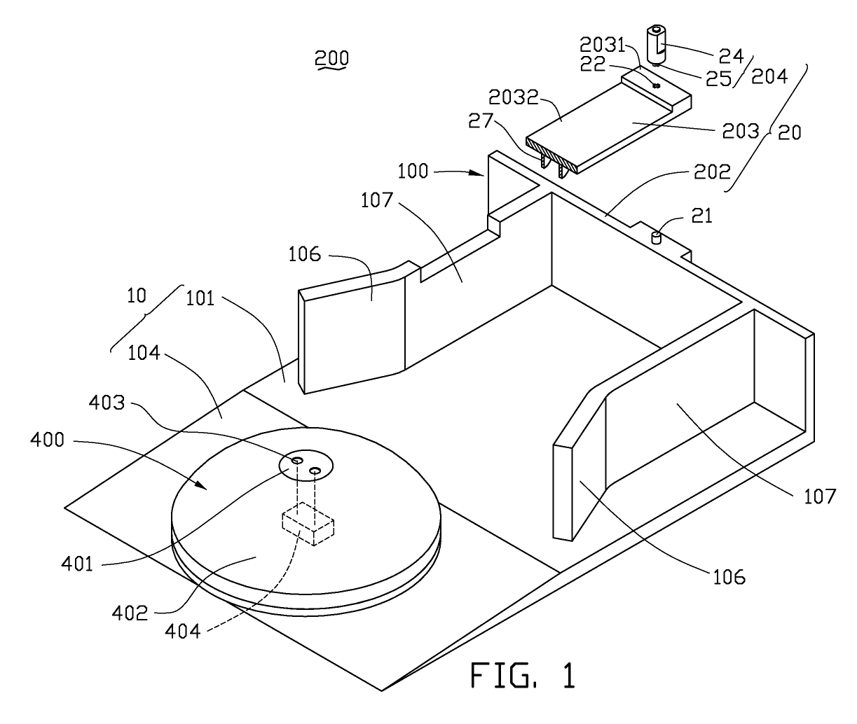

Referring to FIG. 1, a charging system 200 in accordance with an exemplary embodiment includes a robot 400 and a charging apparatus 100 detachably connecting with the robot 400 for charging the robot 400.

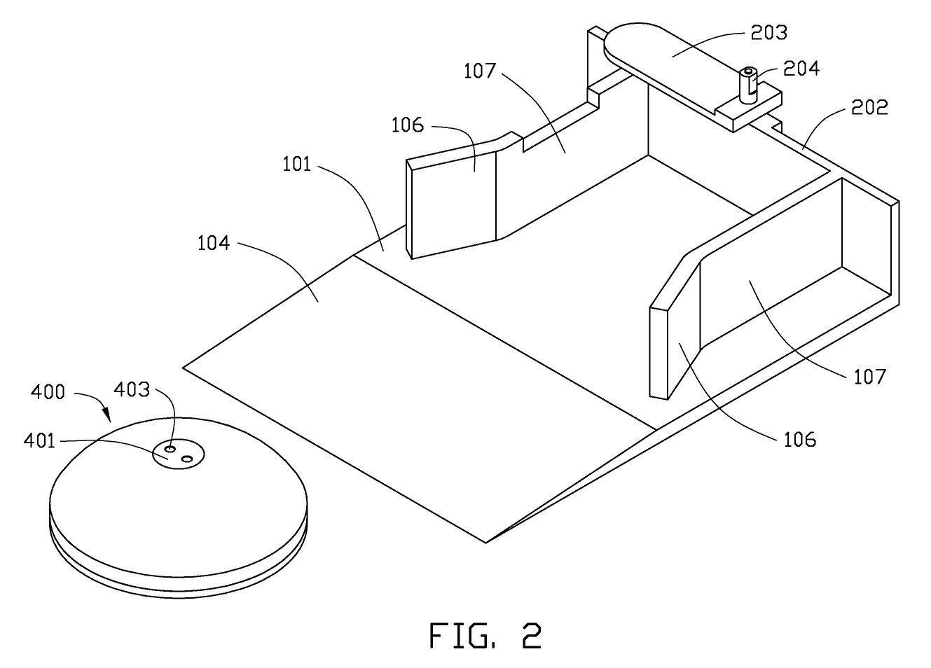

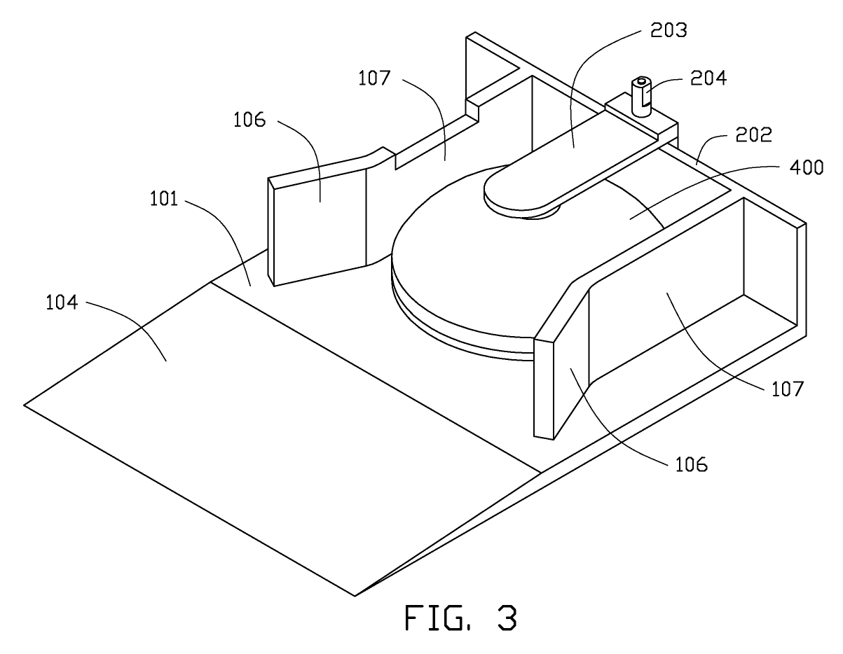

Referring to FIGS. 2 and 3, the robot 400 includes a casing 402, a rechargeable battery 404 installed in the casing 402, and two power receiving terminals 403 electrically connected with the rechargeable battery 404. The casing 402 is substantially a flat circular-shaped. The rechargeable battery 404 is used for providing power to the robot 400. A receiving portion 401 is depressed from an upper center of the casing 402. The two power receiving terminals 403 are disposed in the receiving portion 401 correspondingly.

The charging apparatus 100 includes a base board 10, a charging portion 20, two blocking walls 107, and two guiding walls 106. The charging portion 20, the two blocking walls 107, and the two guiding walls 106 are disposed on the base board 10.

The base board 10 includes a rectangular-shaped flat portion 101 and an inclined portion 104 extending obliquely from a first edge of the flat portion 101. Therefore, the robot 400 can advance to the flat portion 101 from the ground (not shown) via the inclined portion 104.

The charging portion 20 is disposed on a second edge of the flat portion 101 opposite to the first edge, and configured for recharging the rechargeable battery 404 of the robot 400. The charging portion 20 includes a supporting portion 202 disposed on the flat portion 101, a rotating member 203 pivotally attached on the supporting portion 202, a driving member 204 engageable with the rotating member 203, and two power supply terminals 27 disposed on the rotating member 203.

The supporting portion 202 is substantially a wall disposed on the second edge of the flat portion 101. The supporting portion 202 is used for supporting the rotating member 203 and preventing the robot 400 from overreaching its docking position. A shaft 21 is disposed on an upper surface of the supporting portion 202 away from the flat portion 101.

The rotating member 203 is substantially arm-shaped. A fastened end 2031 of the rotating member 203 defines a fixing hole 22 and a pivot hole (not shown). The pivot hole is coaxial with the fixing hole 22. The shaft 21 is inserted into the pivot hole so as to rotatably connect the rotating member 203 on the supporting portion 202.

The driving member 204 includes a motor 24 and a worm 25 connecting with the motor 24. The worm 25 is inserted into the fixing hole 22, and may drive the rotating member 203 rotating around the shaft 21, when the motor 24 is activated.

The two power supply terminals 27 are disposed at a free end 2032 of the rotating member 203, and protrude downwardly from the rotating member 203. The free end 2032 and the fastened end 2031 are at opposite ends of the rotating member 203. When the robot 400 approaches the charging apparatus 100, the two power supply terminals 27 may face the two power receiving terminals 403 and electrically interconnect with each other. The power supply terminals 27 are flexible.

The two blocking walls 107 are parallel with each other, and perpendicularly connect with the supporting portion 202 and the flat portion 101 correspondingly.

The two guiding walls 106 extend from the ends of the two blocking walls 107 away from the supporting portion 202 to the first edge of the flat portion 101 correspondingly. The distance between the two guiding walls 106 gradually increases from the ends of the guiding walls 106 connecting with the blocking walls 107, in order to guide the robot 400 to move towards a position between the two blocking walls 107.

When the voltage of the rechargeable battery 404 runs low, the robot 400 may move to the flat portion 101 between the two blocking walls 107 via the inclined portion 104. As the robot 400 moves into the position between the two blocking walls 107 and contacts the supporting portion 202, the motor 24 is activated, such that the worm 25 drives the rotating member 203 to rotate around the shaft 21 in a plane parallel with the flat portion 101, so as to allow the power supply terminals 27 to electrically connect with the power receiving terminals 403 of the robot 400. Therefore, the rechargeable battery 404 of the robot 400 is recharged.

When the power of the rechargeable battery 404 of the robot 400 reaches a predetermined level, the motor 24 is also activated to drive the rotating member 203 to rotate around the shaft 21, therefore, the power supply terminals 27 disconnect with the power receiving terminals 403 of the robot 400, the robot 400 may move away from the charging apparatus 100.

The flexible power supply terminals 27 are disposed on the rotating member 203 and pivotally attached on the supporting portion 202. Thus, when the power supply terminals 27 rotates with the rotating member 203, the power supply terminals 27 avoid damaging or scraping the robot 400 because of its flexible.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A charging apparatus comprising:
a base board for loading a robot;
a supporting portion disposed on the base board;
a rotating member rotatably attached on the supporting portion;
a driving member engageable with the rotating member so as to drive the rotating member to rotate with respect to the supporting portion; and
a power supply terminal disposed on the rotating member and rotating with the rotating member to electrically connect with the robot for recharging the robot.

2. The charging apparatus of claim 1, wherein the power supply terminal is flexible.

3. The charging apparatus of claim 1, wherein one end of the rotating member is rotatably attached on the supporting portion, and the power supply terminal is disposed on the other end of the rotating member.

4. The charging apparatus of claim 1, wherein the rotating member rotates in a plane parallel with the base board.

5. The charging apparatus of claim 1, wherein the base board comprises a flat portion and an inclined portion obliquely extending from the flat portion, and the supporting portion is disposed on the flat portion.

6. The charging apparatus of claim 5, further comprising two parallel blocking walls disposed on the flat portion and connecting with the supporting portion.

7. The charging apparatus of claim 6, further comprising two guiding walls extending from the end of the two blocking walls away from the supporting portion.

8. The charging apparatus of claim 7, wherein a distance between the two guiding walls gradually increases from the ends of the guiding walls connecting with the blocking walls.

9. The charging apparatus of claim 5, wherein the inclined portion and the supporting portion are disposed at opposite sides of the flat portion.

10. A charging system comprising:
a robot with at least one power receiving terminal disposed on the upper center; and
a charging apparatus comprising:
a supporting portion;
a rotating member pivotally attached on the supporting portion; and
at least one power supply terminal disposed on the rotating member, the at least one power supply terminal rotating along with the rotating member to contact with the power receiving terminal for recharging the robot.

11. The charging system of claim 10, wherein one end of the rotating member is attached on the supporting portion, the at least one power supply terminal is disposed on the other end of the rotating member.

12. The charging system of claim 10, wherein the at least one power supply terminal is flexible.

13. The charging system of claim 10, wherein the charging apparatus further comprises a base board for loading the robot, and the supporting portion extends from the base board.

14. The charging system of claim 13, wherein the base board comprises a flat portion and an inclined portion obliquely extending from the flat portion.

15. The charging system of claim 14, wherein the charging apparatus further comprises two parallel blocking walls disposed on the flat portion and connecting with the supporting portion.

16. The charging system of claim 15, wherein two guiding walls extending from an end of the two blocking walls away from the supporting portion.

17. The charging system of claim 16, wherein a distance between the two guiding walls gradually increases from ends of the guiding walls connecting with the blocking walls.
